(19) United States
(12) Patent Application Publication
(10) Pub. No.: US 2011/0202326 A1
(43) Pub. Date: Aug. 18, 2011

(54) MODELING SOCIAL AND CULTURAL CONDITIONS IN A VOXEL DATABASE

(75) Inventor: LEO SALEMANN, SAMMAMISH, WA (US)

(73) Assignee: LOCKHEED MARTIN CORPORATION, BETHESDA, MD (US)

(21) Appl. No.: 12/707,158

(22) Filed: Feb. 17, 2010

(51) Int. Cl. G06F 17/30; G06G 7/48

(52) U.S. Cl. 703/6; 707/802; 707/769; 707/E17.044; 707/E17.014

(57) ABSTRACT

A set of digital products of a real-world volumetric space comprising a population of humans can be received. The digital products can be analyzed to determine a set of social characteristics and cultural conditions for the population. The determined social characteristics and cultural conditions can be stored in a voxel database. The social characteristics and cultural characteristics can be recorded with geospatial metrics for the real-world volumetric space in which they occurred. A computer model can be generated for a geospatially bound simulation space from the voxel database data. The computer model can include the social characteristics and cultural characteristics of the geospatially bound simulation space. The computer model can be used by a simulation device to model behavior of a simulated culturally linked population corresponding to the population for the real-world volumetric space.

### BACKGROUND

The present disclosure relates to the field of behavioral modeling, simulation, and geographic information systems and, more particularly, to modeling social and cultural conditions in a voxel database. One aspect of the disclosure takes an epidemiological approach to modeling the spread of ideas and attitudes through a culturally-linked population.

Epidemiology studies factors affecting the health and illness of populations. When an outbreak for a particular disease occurs, geospatial data specific to the disease and recorded occurrences of it can be gathered. Gathered data can be analyzed to determine patterns. Knowledge of these patterns can permit analysts to backtrack an outbreak to its cause, or to at least identify an approximate geographic point of origin and time of origin. Additionally, disease spread patterns can further be used to forecast a future spread of a disease among a population and to predict how geographic areas and populations included therein will be affected by a disease. Armed with this information, mitigation efforts can be taken to minimize disease spread and to reduce health risks.

It should be understood that epidemiological models are probabilistic in nature and are based upon causal relationships. Epidemiology models can be formed using a collection of statistical tools used to elucidate the associations of exposures to health outcomes. Even though epidemiology is based on causal relationship, inference is key. That is, it is nearly impossible to say with perfect accuracy how even the most simple physical systems behave beyond the immediate future, much less the complex field of epidemiology, which draws on biology, sociology, mathematics, statistics, anthropology, psychology, and policy.

Behavioral analysis models have been used in epidemiology to help understand how patterns of human contact aid or inhibit the spread of diseases such as HIV in a population. The mapping techniques used in epidemiology, however, are not known to have been applied to generic behavioral models.

### BRIEF SUMMARY

One embodiment of the disclosure utilizes an epidemiological approach to modeling the spread of ideas and attitudes through a culturally-linked population. A volumetric space, of a computer-based simulator can include a simulated population of humans. This simulated population can be exposed to selectable behavioral events, such as an outbreak of extremism. This behavioral outbreak can be handed by the computer-based simulator in a manner analogous to a manner in which an epidemiological outbreak is handled.

In one embodiment, the volumetric space can be populated with data captured from a real-world volumetric space related to a real-world population. That is, the simulated population and behavioral model for this simulated population can correspond to a real-world situation.

One aspect of the disclosure can receive a set of digital products of a real-world volumetric space comprising a population of humans. The digital products can be analyzed to determine a set of social characteristics and cultural conditions for the population. The determined social characteristics and cultural conditions can be stored in a voxel database. The social characteristics and cultural characteristics can be recorded with geospatial metrics for the real-world volumetric space in which they occurred, wherein regular volumetric units of the real-world volumetric space correspond to uniquely identified voxels in the voxel database. The storing of the determined social characteristics and cultural conditions can include indexing values for the determined social characteristics and cultural conditions against a set of records, each of which comprises a unique voxel identifier for one of the voxels to which a corresponding regular volumetric unit relates. A behavioral model can be generated for a geospatially bound simulation space from the voxel database data. The generated behavioral model can include the social characteristics and cultural characteristics of the geospatially bound simulation space. The generated behavioral model can be used by a simulation device to model behavior of a simulated culturally linked population corresponding to the population for the real-world volumetric space.

Another aspect of the disclosure can define a volumetric simulation space of a simulator comprising a simulated population. Social characteristics and cultural conditions for the simulated population can be extracted from a voxel database. Voxels of the voxel database can correspond to regular volumetric units of the volumetric simulation space. A user interface can be presented that includes user interface fields for a defined set of social characteristics, a set of cultural conditions, and region boundary defining options. The user interface fields can each be adjustable based upon user input received via the user interface. At least one value threshold can be established for the social characteristics to determine if a given sub-region is affected by the social characteristics. At least one sub-region of the bound geospatial region can be determined that satisfies the value threshold of the social characteristic set given the cultural conditions at a defined time. A map of a bound region of the volumetric simulation space can be presented within the user interface, wherein the bound region is in accordance with the region boundary defining options. Each determined sub-region can be visually shown in the user interface in a visually distinguishable way to indicate the presence and geospatial boundaries of the social characteristic satisfying the value threshold at the defined time.

Another aspect of the disclosure is for a voxel database for storing social characteristics of culturally linked populations within an indexed tangible storage medium. The voxel database can include a set of voxel records in a voxel table. Each of the voxel records can have a unique voxel identifier. The voxel database can include hardware and computer program products stored on a tangible storage medium and executable upon the hardware. The voxel table can be stored in a tangible storage medium. Each voxel record can include visual attributes of a geometric space. Each uniquely defined voxel of voxel database can be a volume unit on a grid (regular or non-regular) in three dimensional (3D) space, which is a voxel space. A correspondence can exists between voxels in the voxel space and volume units of a real world volumetric space from which geospatial data was directly gathered and encoded within the voxel database. The voxel database can also store a set of population records. Each population record can have a unique identifier for a set of one or more people. Each population record can include a set of different attributes for social characteristics of the corresponding set of people. The voxel database can also include a set of time dependent records. Each record can associate a unique one of the population records to unique set of one or more voxels, at a specific time defined in the time dependent records.

Another aspect of the disclosure can be for determining and presenting social characteristics of a human population in a simulation space of a user interface. A set of geospatial records can be stored in a voxel database, where the records include data from a set of different sources captured at different times for a real-world volumetric space. The records include data for social characteristics of human populations at specific times. Each social characteristic can be indexed against a set of uniquely defined voxels. A first volumetric subspace can be determined from social characteristic data stored in the voxel database and associated with a first time. The first volumetric subspace can be for a population having values for the social characteristic data falling within a defined range at the first time. The first volumetric subspace can be a continuous volume that directly maps to regular volumetric units of a simulation subspace, which have a correspondence to voxels of the voxel database. A second volumetric subspace can be determined from social characteristic data stored in the voxel database and associated with a second time. The second volumetric subspace can be for the population having values for the social characteristic data falling within the defined range at the second time. The second volumetric subspace can be a continuous volume that directly maps to regular volumetric units of the simulation subspace. The second volumetric subspace can be different from the first volumetric subspace. A request can be received for presenting a volumetric subspace for the population having values of the social characteristic data within the defined range at a third time. Boundaries of a third volumetric subspace can be determined by establishing a mathematical relationship between the first, second, and third times and applying the established mathematical relationship to the first, second, and third volumetric space, thereby interpolating boundaries of the third volumetric space from the first volumetric subspace and the second volumetric subspace. A representation of the third volumetric subspace can be visually presented within a simulation space of a simulation user interface along with an indication that the third volumetric subspace visually represents a geospatial region comprising a human population predominantly possessing the defined range of social characteristics at the third time.

Another aspect of the disclosure is for simulating changes to social characteristics of a geospatially located population within a software driven simulator. A set of digital products can be generated for a real-world volumetric space using automated sensors, which capture real-world data. The digital products can include information from which social and cultural data for human populations is able to be automatically determined. The social and cultural data can be specific to a specific time at which data was captured for from the real-world volumetric space. Different digital products can be acquired at different times, which results in the social and cultural data being captured for the real-world volumetric space at different times. Data of each of the digital products can be recorded in a voxel database. Voxels of the voxel database can correspond to regular units of volumetric space of the real-world volumetric space associated with the digital products being recorded in the voxel database. The voxel database can include cultural and social data for populations at different times, which are linked to specific voxels within the voxel database. The voxel database can also include records storing visual data of the real-world volumetric space. The visual data can be stored in raster format and can be related to different unique voxel specific records of the voxel database. A simulated space can be generated within a simulation user interface based data extracted from the voxel database. Visual elements of the simulated space can be directly rendered from the visual data stored in raster format by a voxel rendering engine of a simulator that includes the simulation user interface. The simulation space can depicts a state of information at specific time. A delineated sub-region can be visually expressed within the simulated space that denotes a social characteristic of a simulated population present in the sub-region at the specific time. The social characteristics data used to generate the simulation space can be extracted from the social data of the voxel database. A correspondence can exist between volumetric units of the real-world volumetric space and voxels of the voxel database. A correspondence can exist between volumetric units of the simulation space and voxels of the voxel database.

### BRIEF DESCRIPTION OF THE SEVERAL VIEWS OF THE DRAWINGS

FIG. 1 is a schematic diagram showing a voxel database managing spatially referenced behavioral data for a simulated population in accordance with an embodiment of the disclosure.

FIG. 2A describes an embodiment for populating and using a voxel database and a simulator able to consume data of the voxel database.

FIG. 2B shows embodiments for simulators and simulator interfaces in accordance with an embodiment of disclosure.

FIG. 2C shows embodiments for simulator interfaces in accordance with an embodiment of disclosure.

FIG. 2D shows a method for interpolating volumetric spaces used to represent social characteristic values of included population in accordance with an embodiment of the disclosure.

FIG. 3A is a flow chart of a process to acquire voxel database information from a data source in accordance with an embodiment of disclosure.

FIG. 3B is a set of flow charts for utilizing data of a voxel database in accordance with an embodiment of disclosure.

FIG. 4 is a schematic diagram of a system including a voxel database in accordance with an embodiment of disclosure.

FIG. 5 demonstrates aggregation efficiency of a voxel database and a relationship between voxels, shapes, and features in accordance with an embodiment of disclosure.

FIG. 6 illustrates a set of tables for a voxel GIS in accordance with an embodiment of the disclosure.

### DETAILED DESCRIPTION

The disclosure provides a volumetric storage space 120 in which social characteristics and/or cultural conditions are recorded. In one embodiment, the social characteristics and/or cultural conditions can be determined by analyzing behavior, clothing, gestures, and the like of a sub-volume 115 of a real-world volumetric space 110. In one embodiment, social characteristics and/or cultural conditions stored within a volumetric storage space 120 can be applied to a simulation space 140. For example, attitude, attire, behavior, and the like of a simulated population 144 can be adjusted based upon social characteristics and/or cultural conditions of a sub-volume of volumetric storage space 120 corresponding to a sub-volume 143 of the simulation space 140. In one embodiment, an epidemiological approach is taken to model the spread of ideas and attitudes through a culturally-linked population, where this epidemiological approach is supported by volumetric storage space 120.

The volumetric storage space 120 can be a space composed of a set of volumetric units, called voxels 122. Data elements can be directly referenced to voxels 122, which permits these data elements to be spatially placed in the volumetric storage space 120. The data elements need not have any specific identity outside their relationship to the voxels 122, which permits raw data to be inserted into the volumetric storage space 120. For example, satellite imagery, LIDAR points, and other information can all be inserted into the volumetric storage space 120 and referenced to voxels 122. The other information can include social characteristics and cultural conditions of a specific volumetric unit. Further, the information inserted in the volumetric storage space 120 can include images of populations 114, buildings, etc, which can be analyzed to determine social characteristics and/or cultural conditions of a given region (sub-volumetric space). Viewed in one manner, each voxel 122 can be thought of as a three dimensional puzzle piece that fits together with other puzzle pieces to form the volumetric storage space 120. Information included in the volumetric storage space 120 can be extracted post-storage. For example, outlines of objects can be detected within the volumetric storage space 120 to determine a presence or absence of a building, vehicle, crowd, or other object within the volumetric storage space 120.

It should be noted that data elements can be continuously inserted into the volumetric storage space 120. In this manner, data elements can be combined to continuously increase a “resolution” of the data image contained within the volumetric storage space 120. In one embodiment, the volumetric storage space 120 can be a probabilistic one. In other words, data elements can be stored in the volumetric storage space 120 that have a probability of being contained therein but have a probability of not actually being contained therein. For example, if an incomplete “data image” of a building (which can be formed by 1 . . . N quantity of voxels) exists in the volumetric storage space 120, an associated probability of the building being present in the volumetric storage space 120 can be at a value of forty percent where a sixty percent probability value exists that the building is not present in the volumetric storage space 120. Thus, the volumetric storage space 120 is able to handle uncertainty of data elements in a manner that traditional storage spaces cannot. Probabilities can also apply to social characteristics and cultural conditions determined by processing data of the volumetric storage space 120.

The volumetric storage space 120 can store data elements of any nature. For example, the data elements of the volumetric storage space 120 can include visual information in two or three dimensions. Data elements can also include material composition elements, elevation data, and the like. Any type of information that can be spatially related to a volumetric unit (e.g., voxel) can be stored in the volumetric storage space 120.

Another way of expressing the volumetric storage space 120 is by using database terminology. Stated differently, each voxel 122 can have a unique identifier, which in a database system (e.g., database 130) can be a primary key of a database table having voxel records. Data elements of the volumetric storage space 120 can be attributes of the voxel records. Relative reference points of data elements within a corresponding voxel can be optionally recorded, should a spatial positioning of a data element be needed at a level of granularity less than a single voxel 122. The only linkage of each data element within the database 130 can be defined by its relationship to a voxel 122. That is, instead of referencing visual, material, or other characteristics of a building to that building, as would be the case with a standard database—visual, material, or other characteristics can be referenced directly to voxels 122.

This ability to relate any number of characteristics (e.g., data elements) having a spatial component to the volumetric storage space 120 at a suitable spatial location (via voxel referencing) is significant and unique to a voxel database 130. It is this ability that permits “raw” data to be directly inserted into the volumetric storage space 120. The raw data (e.g., satellite data, for example) when acquired is typically formatted in a spatial manner well suited for proper insertion into the volumetric storage space 120. Otherwise, input acquired from satellites (or similar sources) must be processed and categorized to specific objects (e.g., buildings, roads, etc). These objects are typically stored in databases as discrete entities having object specific attributes. Each time processing occurs, a data loss can result, as assumptions, which must be made during processing, may not be true. For example, during processing, material composition attributes are historically stored against to objects (e.g., buildings, roads, etc.) formed from these materials. There may be, however, uncertainty in which of a set of possible objects are actually present in a given spatial region. Thus, during processing, material composition attributes can be stored against the wrong objects. Conventional practices (that do not utilize a volumetric storage space 120) may attempt to correct for processing errors, as described above. Error correction techniques, however, do not change the fact that there is a fundamental disconnect with the paradigm used for storing data given the manner in which this data is acquired. Use of a volumetric storage space 120 is believed to resolve this disconnect, and believed to achieve numerous advantages as described herein.

As used herein, a social characteristic is a distinguishing feature able to be used to distinguish one person or group of people from each other. The disclosure is predominantly concerned with social characteristics that have a nexus with a specific region or of a definable volumetric space. For example, a given geographic region can have a different mix of ethnicity within a general population 114 than another. Social characteristics can include physical characteristics such as height, skin tone, facial features, and the like. Other characteristics can include native language, political affiliation, religion, and the like. Behavior, such as aggression/passiveness/marketplace ethics/etc. can all be determined based upon social characteristics.

Cultural conditions as used herein refer to a distinguishing feature of a region (non-person specific) that distinguishes that region from another. For example, architecture style, general level of technology, predominance of public transportation, computer technology level, medial infrastructure, police infrastructure, and the like are all cultural conditions that are distinguishable from one region (volumetric space) to another.

The disclosure focuses on determining region-specific commonalities that vary from region to region for both social characteristics and cultural conditions. Once these commonalities are defined by region, different adaptive models can be created to simulate different social characteristics and cultural conditions within simulation space 140 as needed or desired. Thus, a “base” model of a population and building can be adapted within a simulation space 140 to be specific to a definable region. Similarly, differences present in acquired data 113 can permit cultural conditions and social characteristics of a region to be properly characterized.

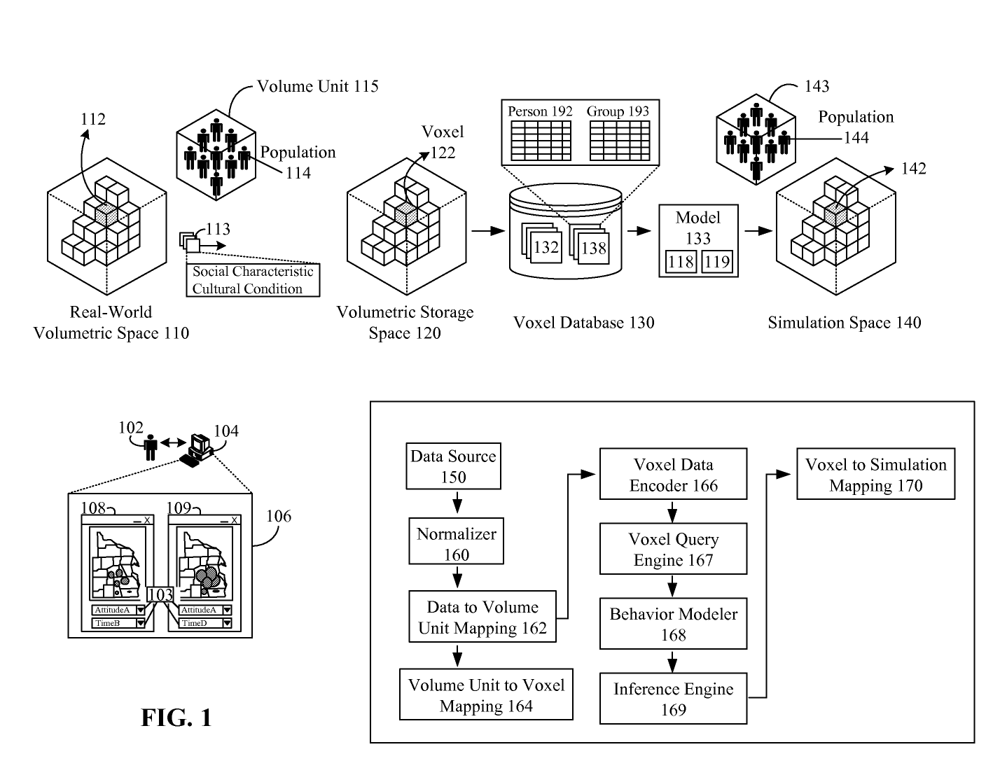

FIG. 1 is a schematic diagram 100 showing a voxel database 130 managing spatially referenced social characteristics and cultural conditions. Records 132, 138 of the voxel database 130 can be used to construct a model 133 for a simulated population 144 of simulation sub-space 143. The models 133 can model cultural conditions and social characteristics. In one embodiment, parameters for cultural conditions and social characteristics can be adjusted within the model 133, which results in changes to the simulated population 144 and environment within which the population 144 operates.

More specifically, voxel indexed records 132 can include a set of records, each having a unique voxel 122 identifier. Population records 138 can include a set of records indexed against people (person table 192) and/or groups (group table 193), where each record of the person table 192 has a unique person identifier, and where each record of the group table 193 has a unique group identifier. Groups and/or people can be positioned in a volumetric space 120, where locations of groups and/or people in the volumetric storage space 120 can vary over time. Voxel database 130 mappings can be maintained between unique voxels 122 and unique people (table 192) and/or groups (193). Additional records and data elements can be recorded in database 130, and the person 192 and group 193 table is shown for illustrative purposes only.

Similarly, attitudes, beliefs, ideas, and other social characteristics can be associated with specific people (table 192) and groups (table 193). Various cultural conditions can be defined for populations (192, 193) and geospatial regions (voxel space 120) that affect a propagation of social characteristics among people and groups. Cultural conditions, social characteristics, geospatial regions, and other such information can be encoded in a computer model 133, which can be generated from information of voxel database 130. In one embodiment, the model 133 can include social item 118 and culture item 119. The social item 118 can be person-group related items, which are constrained to a stable volumetric space (set of voxels 122). The culture item 119 can be model items associated with buildings, weather, or other person independent characteristic. Relationships between social 118 and cultural items 119 can be dynamic (e.g., populations can be mobile and able to traverse geographic space over time).

In one embodiment, the model 133 can be used to determine a state of (or spread of) social characteristics or cultural conditions. Additionally, the model 133 can permit forecasts concerning a future social and/or cultural state of the simulated population 144 or region. The model 133 can be responsive to conditional input, which allows for interactive computer-based scenarios.

For example, a user 102 interacting with a computing device 104 via a user interface 106 can cause the simulation application (hosted on device 104) to generate various simulation screens 108, 109. The screens 108, 109 can include a presentation of a portion of a simulation space 140. Using user interface controls 103, the user 102 can impose behavioral conditions upon a designated region (sub volume 143, which is a bounded volumetric space—for example) of simulation space 140. Given these conditions, behavior of a simulated population 144 can be determined and expressed within screens 108 and/or 109.

In one embodiment, regions affected by a specific social characteristic (user selectable via interface 106) of population 144 members can be distinguished on a map of each screen 108, 109. Behavior, attitudes, and ideas can dynamically change over time. Thus, at one time (e.g., Time B of screen 108, for example) regions having a specific social characteristic can be of an illustrated size for a first model state, which increases for a different model state (Time D of screen 109, for example).

In one arrangement, an epidemiological approach can be utilized. That is, instead of disease incidents being geographically expressed in a user interface, social characteristics can be expressed. Human communication mechanisms (as opposed to disease transmission factors) can be defined in the model 133 and used to determine a transmission of social characteristics. Susceptibility of a social characteristic that a subset of simulation population 144 is exposed to can be based on cultural conditions as opposed to virulence of a pathogen. Cultural conditions can include cultural mores, unrest levels, governmental influence, and other human-based factors.

As used herein, the voxel database 130 can be a database of a geographic information system (GIS) that captures, stores, analyzes, manages, and/or presents data that is linked to a location. In the database 130, records 132 can be mapped or related to voxels 122, each of which has a unique identifier. Each voxel 122 can be a volume element representing a value on a grid in three dimensional space, specifically voxel space 120.

In one embodiment, volume units 112 from a real-world volumetric space can be directly mapped to voxels 122 of voxel space 120. Similarly, real world populations 114 present in or associated with a volume unit 112 can be mapped to voxels 122. Any consistent scale can exist between a volume unit 112 and a voxel 122. For example, for a given geographic region, one or more data sources 150 can utilize a set of sensors to capture and record data 113 for a specific volume unit 112. The data 113 can include social characteristics of the population 114 and cultural conditions affecting the population 114.

Before converting data 113 into voxel 122 mapped records 132 and/or 138, the data 113 can be optionally normalized (by normalizer 160) to a definable standard. A data to volume mapping unit 162 can determine which unit 112 data 113 elements correspond to, should geospatial referencing be needed. Then, volume unit to voxel mapping component 164 can determine which voxel 122 corresponds to which volume unit 112. The voxel database 130 can be associated with a voxel query engine 167, which permits records 132, 138 to be retrieved based on requestor supplied criteria. Voxel data encoder 166 can digitally encode the data 113 into a voxel database format.

In one embodiment, a set of optional filters can be established between the voxel database 130 and a related simulation space 140. The filters can be applied before the behavioral models 133 are generated by the behavior modeler 168. An inference engine 169 can infer social characteristics of the simulation population 144. Mapping of simulated population 144 to real world population 114 characteristics can be performed on a unit-by-unit basis. Thus, volumetric subsets of populations can be handled as units. Voxel to simulation mapping component 170 can perform geospatial mappings from database 130 to simulation space 140.

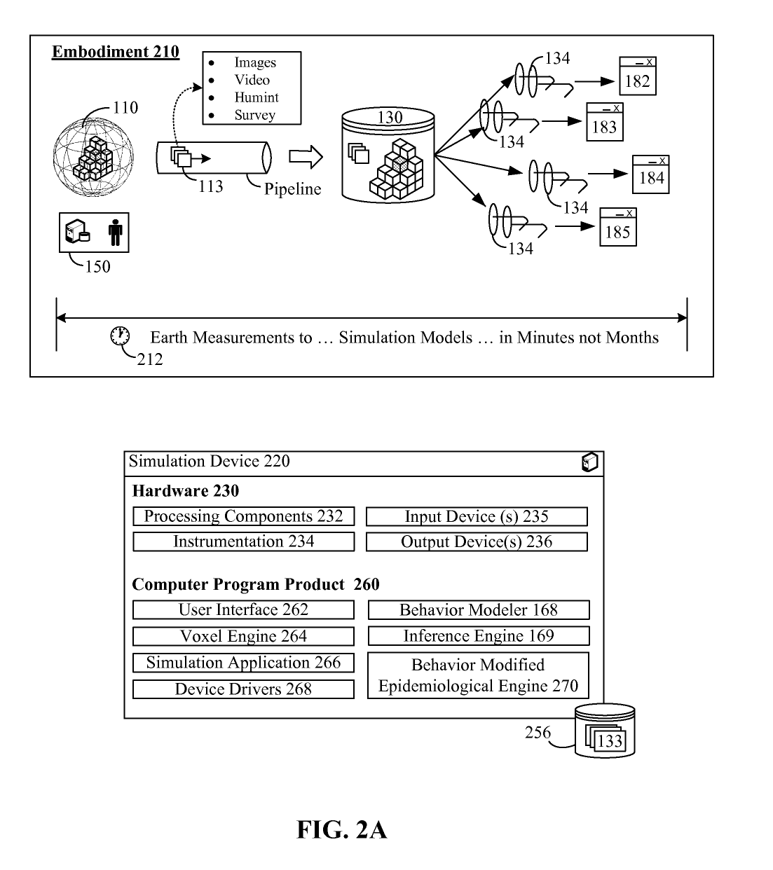

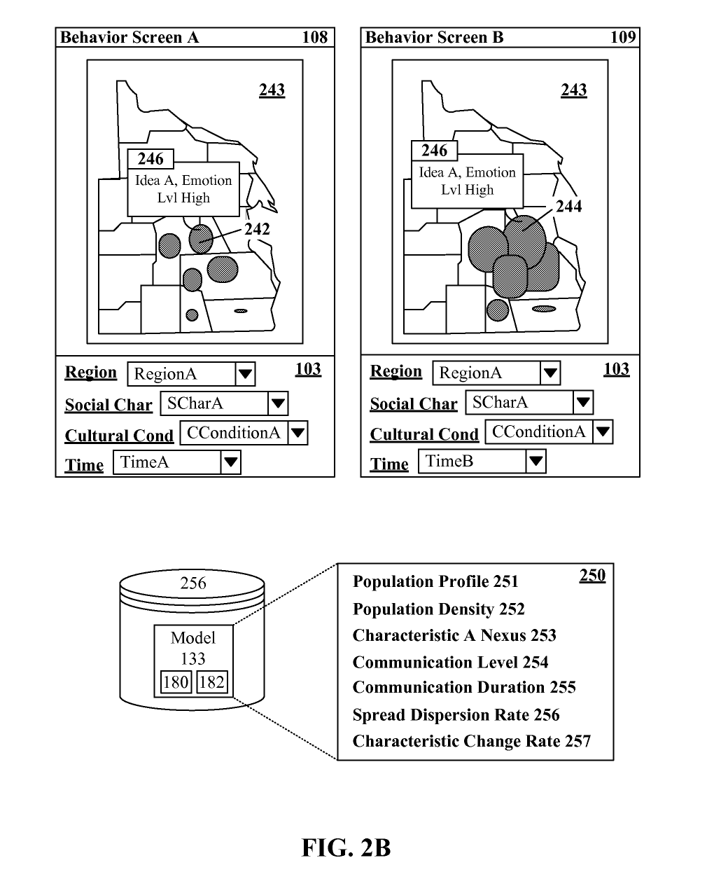

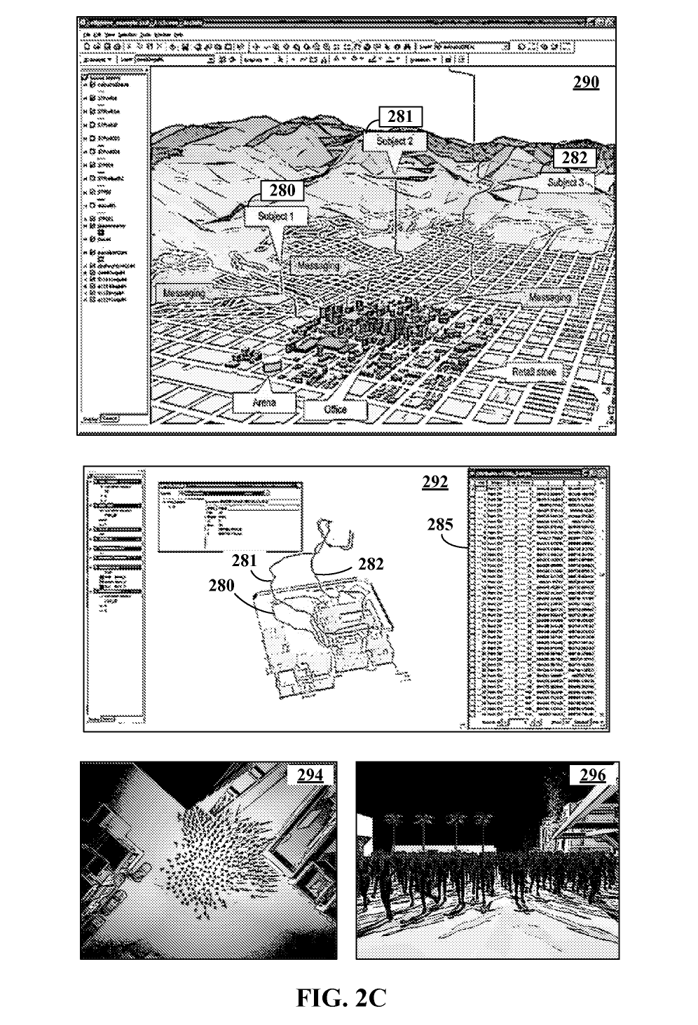

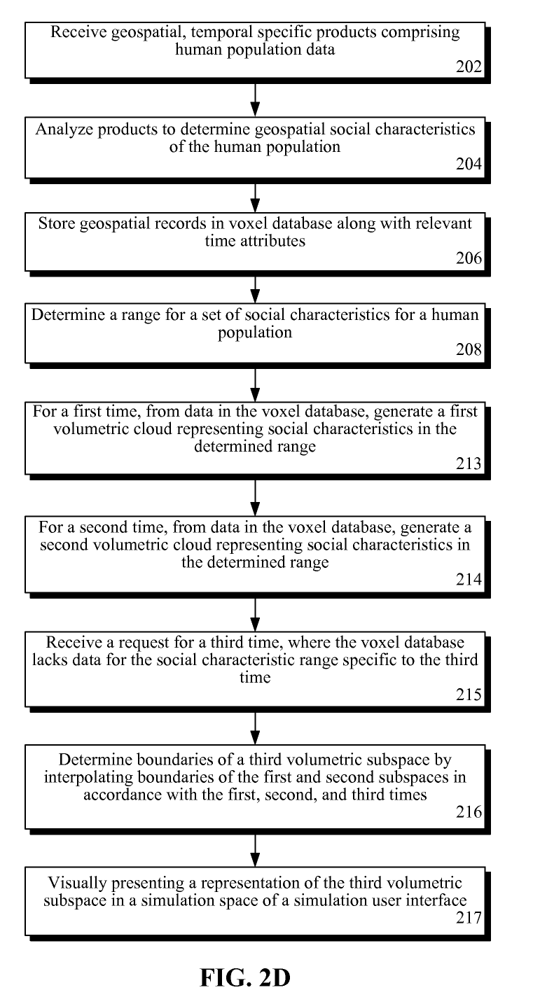

Embodiment 210 of FIG. 2A provides another description for populating and using voxel database 130. It also emphasizes that the database 130 can function as a central repository for a myriad of different types of data, which includes types unrelated to social characteristics, cultural conditions, and behavioral modeling. Using embodiment 210 as a description reference, data (including data 113) captured from a real-world volumetric space 110 can be conveyed over a single pipeline to voxel database 130. The data 113 can come from many sources 150, such as satellite imagery, digital elevation model (DEM) data, video, signals intelligence (SIGINT), human intelligence (HUMINT), Psychological Operations (PSYOPS), and the like. Additionally, the filtered voxel database 130 can provide data for multiple different types of simulators (simulation space 140). For example, behavioral simulations 182, tactical engagement simulators (TES) 183, constructive simulators (e.g., semi-autonomous force (SAF) systems) 184, immersion simulators 185, vehicle simulators, and the like can all operate on voxel database 130 stored records 132.

The common database 130 product can be a probabilistic one in which uncertainty is handled. In one embodiment, query engine 168 can include multiple different components for producing different queries (e.g., mission rehearsal query, training query, analysis query, etc.), which handle uncertainty in different manners for different types of consumers. It should be appreciated that embodiment 210 can be largely automated, which permits the process 212 from taking measurements, to producing simulation models to occur within minutes and not months, as is the case with conventional information gathering and modeling processes.

FIG. 2A also shows a schematic diagram of a simulation device 220 for presenting simulation space 140 data. Simulation devices 220 can vary greatly in terms of hardware 230 and computer program products 260 used, which causes user interfaces 262 (which includes interface 106, in one embodiment) to vary accordingly. As noted from embodiment 210, simulators (device 220) consuming geospatial data from voxel database 130 can include many different diverse types of systems. In one embodiment, a simulation device 220 can be a personal computer running a simulation application, which is an virtual 3D application, such as a computer game or trainer.

The hardware 230 can include a number of components 232-236. Processing components 232 of the hardware 230 can include one or more microprocessors, memory 256, a bus, network cards, and the like. Instrumentation 234 can include radar displays, altimeters, speedometers, and other buttons and gages. Input devices 235 can include a keyboard, mouse, touch screen, joystick, cameras, movement detectors, pressure sensors, temperature sensors, laser sensors (e.g., Multiple Integrated Laser Engagement System (MILES) compliant ones) and the like. The output devices 236 can include visual displays, audio speakers, and/or other sensory output devices (e.g., somatosensory output devices, olfaction output devices, gustation output devices, etc.).

The computer program products 260 of the simulation device 220 can include user interface 262, voxel engine 264, simulation application 266, device drivers 268, behavior modeler 168, inference engine 169, and behavior modified epidemiological engine 270. The device drivers 268 can facilitate communications between an operating system (not shown, but is one contemplated computer program product 264) and a specific hardware (such as devices 234-236).

Voxel engine 264 can be an engine able to consume data of the voxel database 130. In one embodiment, the engine 264 can process a set of voxels 122 or a portion of voxel space 120 consisting of any number of voxels. The voxel engine 264 can generate terrain features for a simulation space 140. That is, engine 264 can include a graphics engine that is voxel-based (as opposed to being vector based). Engine 264 can also directly consume voxel-mapped social characteristic data, cultural condition data, and the like. The voxel engine 264 can handle uncertainty and can inherently be probabilistic in nature. In one embodiment, raw (possibly filtered via filter) voxel data can be used to render video and to produce other model (non-visual) output using output devices 236.

Simulation application 266 can include any executable program that utilizes geospatial data of the voxel database 130. The user interface 262 can be a part of the application 266 code and/or can be a front-end for the application 266 code. The simulation application 266 can utilize modeler 168, engine 169, and/or engine 270 depending on simulation specifics.

For example, (and as shown in FIG. 2B), behavior modified epidemiological engine 270 can utilize principles of computer-based epidemiological systems to show spread patterns of social characteristics of culturally linked populations. Engine 270 can be utilize the data of a constructed behavioral model 133 to render various screens 108, 109 of a simulation application 266 user interface 106. As shown, both screens 108, 109 can present a map 243 for a bound portion of a simulation space 140. The map 243 can be presented in two or three dimensions. On the map, different bound regions 242, 244 can be shown for a specific population characteristic, such as an Idea A and a High Emotion Level as expressed by popup 246. User controls 103 can permit a user to adjust an affected region, a set of social characteristics being focused upon, cultural conditions of the region, and a time of the map 243. For example, screen 108 can show a Time A, while Screen 109 can show a Time B, where region 244 has expanded in size between Time A and Time B. The controls 103 permit speculative changes to be input, which can be processed by modeler 168, engine 169, and/or engine 270 to produce changes in the simulation space 140 rendered in the screen 108, 109.

The cultural conditions and/or social characteristics that are able to be expressed within a simulation application 266 can vary significantly in complexity depending on implementation choices. FIG. 2B contemplates use of a behavior modified epidemiological engine 270 that reduces complexity of human behavioral systems to a relatively rudimentary form, in which populations are treated in mass, as are effects on the populations. That is, the computations of engine 270 can ignore individual characteristics (e.g., from person table 192) and handle social characteristic trends, changes, etc. as a statistically definable geospatial phenomenon. The variables and parameters 250 needed for the engine 270 to function can be extracted from the voxel database 130, when the model 133 is created.

For example, given some relatively simplistic parameters 250, a region 242 can be defined. A center point can exist for the region 242 (Characteristic A Nexus 253), which can vary depending on the social characteristic set selected by controls 103. People (having a specific population density 252) in the region 242 can be expected to communicative the social characteristics (Idea A) with others. A communication level 254, which can depend upon communication technologies present in the geographic region, can be a factor to determine how rapidly the Idea A spreads among a population, which can be a value expressed as a spread dispersion rate 256. A given idea (Idea A) may require a minimum level of exposure (communication duration 255) before a likelihood of the idea spreading occurs. Whether a person is “infected” by the idea can be determined by the characteristic change rate 257 (approximately an infection rate). Different population profiles 251 can define cultural conditions that affect other parameters 250.

It should be appreciated that the simulation device 220 is not limited to any particular expression of social characteristics, which have been derived from voxel database 130 data, and a myriad number of applications for this data in a simulation space 140 are contemplated. That is, a simulator that utilizes an engine 270 analogous to those used by epidemiological systems is one of many possible embodiments.

For example, screens 290, 292 of FIG. 2C show an interface of a simulator that performs space-time behavioral analysis (using modeler 168 and engine 169). Specifically, the voxel database 120 can be used as a geographic information system (GIS) for constructing space-time GIS and associated methods for spatiotemporal analysis, which are utilized by code of application 266. Application 266 (having interface 290) can include numerous geosimulation products, as a scheme for data-mining, knowledge generation and discovery, and geovisualization. The voxel database 130 can also be used as a volumetric space-time GIS as a forensic tool in reality mining massive, complex data-sets for human interaction in social, built, and socio-technical systems. The data 113 for the reality mining can be directly extracted from sensor captured mechanism to reflect various states of a real-world volumetric space 110.

More specifically, movements and activities for three different actors (subject 280, 281, 282) living in a specific region can be tracked. Space-time activities can be represented by different paths shown in screen 292. In one embodiment, the time dimension, can be a fourth dimension of the voxel database 130 (i.e., the voxel database can be implemented as a doxel (dynamic voxel) four-dimensional database). Spatial and temporal operations can be performed on these geometries and the results of those operations may be reflected in an underlying spatiotemporal database (shown generically as table 285, which reflects records of database 130). In one embodiment, structured queries to the database 130 may be reflected visually, geometrically, and cartographically on-screen 190, 192. The on-screen (screen 290, 292) geovisualizations may be used as a user interface to massive underlying datasets. Given a large database of activity-patterns or activity-sequences, a user may use the toolkit to reality mine the data for knowledge discovery. The toolkit can also be used to sweep the parameter-space of complex socio-behavioral simulations, particularly when complex agent-based models are deployed. For example, ModSAF (Modular semi automated forces) implementations often use an agent model to reflect simulated combat actors. The socio-behavioral simulations for these ModSAF actors can result from social characteristics and cultural conditions maintained in the voxel database 130, and encoded in behavioral model 133.

Screens 294 and 296 show that different perspectives are able to be generated for a single simulator (device 220) interactive event. Screen 294 shows a population (exhibiting having behavior driven by model 133 defined social characteristics) from a top-down perspective. Screen 296 shows the same population from a first person perspective. Since voxel engine 264 is natively a volumetric engine, changing perspectives and/or viewpoints in a user interface (e.g., screen 294, 296) is a relatively trivial exercise, at least in comparison to performing similar perspective shift using vector based image rendering/manipulation technologies.

It should be emphasized that visual and behavioral characteristics of a screen (e.g., screen 294, 296) can be modified to express a specific cultural condition or social characteristics. For example, if a software application shows a storefront for a user to interact with a computer agent, then visual cues of this agent can vary based on established cultural conditions and/or social characteristics. For example, in a middle-eastern culture/set of social conditions, interactions can be proceed by different rules using different programmatic assumptions depending on if a purchaser is male or female (and depending on whether the computer agent is male or female). Further, a middle-eastern storefront is expected to bargain towards a purchase price, which is otherwise unadvertised. A skill with bargaining will likely effect an outcome of the final charged price. In contrast, if the same basic interactions occurred in an American setting (assuming American social characteristics and cultural conditions) price of items will be relatively fixed and gender of a shopper largely irrelevant to the final outcome of a deal. Attire, accent, inventory, shop layout, and other characteristics of the shop can all vary based on configurable social characteristics and cultural conditions.

FIG. 2D shows a method for interpolating volumetric spaces used to represent social characteristic values of included population in accordance with an embodiment of the disclosure. The method emphasizes that social characteristics can be stored in the voxel database 130 along with temporal or time specific attributes. That is, the social characteristics are expected to change over time for a real world population. Thus, when data of a voxel database is extracted from real-world intelligence, different temporally valid sets of geospatial records for the same social characteristics will need to be maintained. These maintained records can, however, be used to generate additional temporal value points using volumetric interpolation techniques.

In step 202 of the method, geospatial and temporal specific products comprising human population data can be received. These products can be analyzed to determine geospatial characteristics of human populations, as shown by step 204. For example, video products (and still graphics) can be analyzed for human behavioral patterns, from which social characteristics can be determined. In step 206, geospatial records can be stored in the voxel database along with relevant time attributes and social characteristic values.

In step 208, a range for a definable set of social characteristics for a human population can be determined. Records of the voxel database can be queried for values of these social characteristics at two different times, referred to as a first time and a second time for clarity. In step 213, at a first time, a first volumetric cloud can be generated. This volumetric cloud can represent a geospatial region having social characteristics within the defined range. In step 214, other voxel records can be queried for the second time. A second volumetric cloud can be generated based on query results. In step 215, a request can be received which is for a third time, which is a time different from the first and second time. No voxel database information is assumed to exist for the third time. In step 216, boundaries for the third volumetric subspace can be calculated from the first and second volumetric subspaces. That is, boundary points for the third volumetric subspace can be mathematically interpolated using the first and second subspaces given the first, second, and third times. The third volumetric subspace can be visually presented within a simulation space of a simulation user interface. The user interface can indicate that the third volumetric subspace represents a geospatial region having the defined range of social characteristics at the third time.

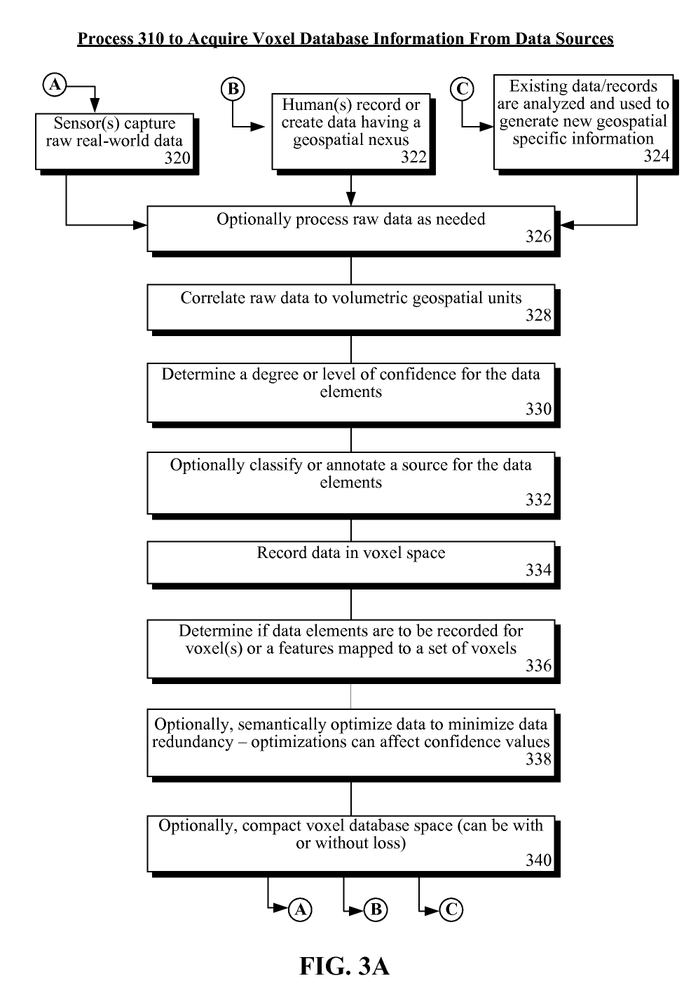

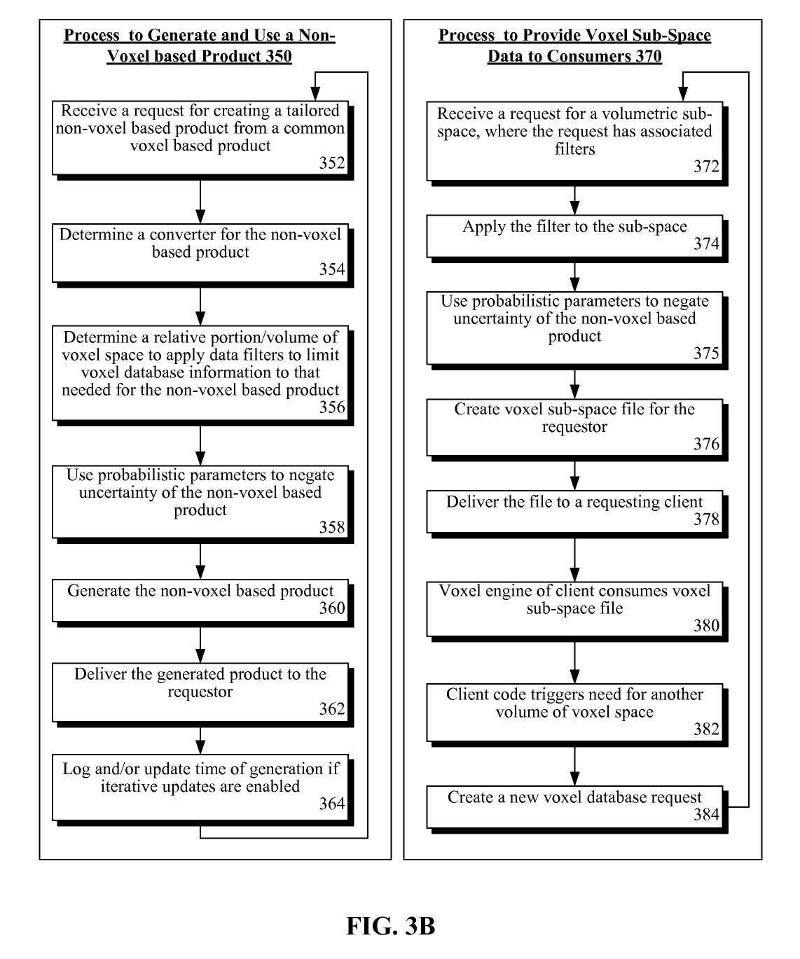

FIG. 3A shows a process 310 to acquire voxel database 130 information from a data source 150 in accordance with an embodiment of disclosure. In process 310 data can be continuously received from a variety of sources, which include completely automated data capture sources (step 320), human data sources (step 322), and generating new intelligence data (or other information) by analyzing and combining existing source data (step 324). This data can be continuously being handled by the process, as represented by process 310 proceeding from step 340 to steps 320, 322, and/or 324. In process 310, data acquisitions and processes can occur in real-time or after an appreciable delay (e.g., handled in batch) depending upon implementation choices. Further, process 310 actions can occur asynchronously/synchronously as well as cyclically/randomly/based on conditional events depending on contemplated implementation choices.

Regardless of how raw data is gathered (step 320, 322, or 324), the data can be optionally processed as needed, as shown by step 326. In step 328, the raw data can be correlated to volumetric geospatial units and/or to populations present in the units. For example, data can be mapped to absolute or relative points in geographic space. Data can also be mapped to human and/or human sets, that reside within geographic space and that have an ability to move from one unit of geographic space to another.

In step 330, a degree or level of confidence for the mapped data elements can be determined. In optional step 332, data elements can be classified in accordance to a source type and/or a specific data source can be tagged or otherwise related to the data elements.

The data elements can be recorded in voxel space meaning the data elements can be encoded into a voxel database, as shown by step 334. The voxel database can optionally establish features composed of one or more shape primitives. These features can be related, such as through relational database (RDBMS) indexes and database primary/secondary keys, to voxels. An RDBMS is one contemplated indexing tool and other indexing mechanisms can be used with the disclosure. When data elements are recorded in voxel space, a determination can be made as to whether each data element is to be referenced against a set of one or more voxels, against a defined feature, or both, as indicated by step 336.

In optional step 338, data can be semantically optimized to minimize data redundancy. For example, approximately equivalent data from multiple sources can be combined into a common data element. This semantic combination can affect confidence values associated with a data element. For example, when multiple sources report a single data element consistently, a confidence value in that data element will increase. In optional step 340, a voxel database space can be compacted to minimize storage requirements. Different voxel (e.g., raster based) compaction algorithms can be utilized, which include loss-less compaction algorithms and lossy compaction algorithms.

The voxel database populated though a process, such as process 310, can thereafter be treated as a common repository or centralized source for geospatially related information. This centralized source can be utilized by different consumers in different ways. In one scenario (process 350 shown in FIG. 3B), the voxel database can be used to generate a non-voxel based product, such as a behavioral model. The behavioral model and associated dataset can be executed by a behavioral engine of a simulator. In another scenario (process 370 shown in FIG. 3B), the voxel database can provide voxel-subspace data sets to requestors, which these requestors can consume directly utilizing an internal voxel engine.

Process 350 can begin in step 352, where a request is received by a voxel database server. The request can be for creating a tailored non-voxel based product from a common voxel based product. An appropriate converter for the request can be determined in step 354.

In step 356, a relative portion or volume of voxel space needs to be determined. That is, the request will rarely be for an entire volume region stored by the voxel database, but will likely be for a volumetric subspace specifically needed by the non-voxel based product. Additionally, data within the requested volumetric subspace can be filtered by applied data filters, so that only the information needed for a specific product of the request is considered. In step 358, probabilistic parameters can be utilized to negate uncertainty inherent in the voxel database when generating the non-voxel based product. Different thresholds and/or parameters can be utilized to determine what level of uncertainty is to be retained within the non-voxel based product, which is generated in step 360. The generated product can be delivered to the requestor in step 362.

Some generated products can require periodic updates form the voxel database in order to retain information currency. In one embodiment, optimizations can be implemented so that only relatively new information needs to be considered for some update operations. When iterative updates are a concern, information can be logged and/or time attributes of the voxel database can be updated as appropriate, which is shown by step 364. The process 350 can repeat as needed, which is expressed by proceeding from step 364 to step 352.

Process 370 can begin in step 372, where a request for a volumetric sub-space is received. The request can have a set of associated filters. Unlike process 350, it is contemplated that a requestor of process 370 can directly consume voxel encoded information. In step 374, the filter can be applied to the voxel sub-space to conditionally exclude data of the voxel database. This is important as the voxel database can be a centralized repository that stores a myriad of data attributes in a voxel related manner, where only a subset of the data attributes are of concern for a specific requestor. In optional step 375, probabilistic parameters can be applied to negate uncertainty when generating the voxel sub-space. This optional step 375 can be utilized when satisfying a request (step 372) for a non-probabilistic voxel subspace.

In step 376, a file (or set of files) containing the requested information can be created. In step 378, the created file(s) can be delivered to a requesting client, such as by delivering the file(s) over a network. A voxel engine of the client can consume or utilize the voxel sub-space file, as shown by step 380. In one embodiment, the voxel database can be directly accessible and used by the clients, in which case a creation and utilization of a locally create file (of a voxel subspace) can be unnecessary.

In one embodiment, the voxel sub-space files can be encoded in a local media storage area (e.g., hard drive) for use by a client as needed. This prevents a need for continuous and/or stable network connectively between the client and the voxel database. In one embodiment, suitable voxel sub-space laden files can be encoded in a portable medium (e.g., optical, magnetic, or other) and disseminated/located to clients periodically.

In another embodiment, data sets can be continuously requested by a client as a simulator needs a data for a different volumetric space. That is, executing client code can trigger a need for another volume of voxel space, as shown by step 382. When no local cache exists for this needed information, a new voxel database request (submitted over a network) can be created, as shown by step 384, which results in the request being handled in step 372.

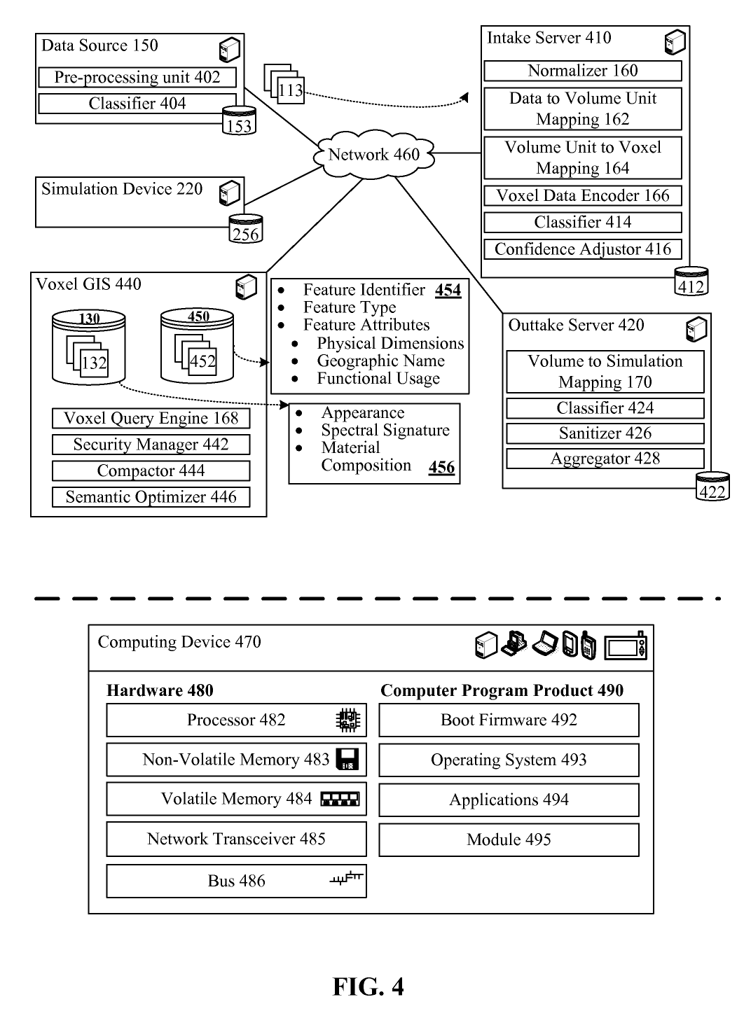

FIG. 4 is a schematic diagram of a system 400 including a voxel database 130 in accordance with an embodiment of the inventive arrangements disclosed herein. In system 400, a set of data sources 150, a set of simulation devices 220, an intake server 410, an outtake server 420, a Voxel geographic information system 440, and other such components can be communicatively linked via a network 460. In lieu of connectivity via network 460, components of system 400 can exchange information via portable media data exchanges, paper document correspondences, human-to-human communications, and the like. The shown components (as items 150, 410, 420, 220, 440) represent one embodiment of the disclosure and are not to be construed as being a limitation of the disclosure's scope.

Various components of system 400, such as items 150, 410, 420, 220, 440, can include one or more computing devices 470, which can include hardware 480 and computer program products 490. The computing devices 470 can be general purpose computing devices, such as personal computers, servers, or in-vehicle computers. The devices 470 can also be special purposed devices specifically manufactured/constructed for a tailored purpose. A special purposed device can have unique hardware, electronic boards, firmware, etc, which is not able to be easily modified by software and used for a different purpose. In various embodiments, devices 470 can be implanted as stand-alone devices, as virtual devices, as distributed devices, as cooperative devices, and the like.

Hardware 480 can include a processor 482, nonvolatile memory 483, volatile memory 484, network transceiver 485, and other components linked via a bus 486. The computer program products 490 can include programmatic instructions that are digitally encoded in a memory (e.g., memory 483, 484) and able to be executed by the processor 482. Computer program products 490 include boot firmware 492, (e.g., basic input/output system (BIOS)), an optional operating system 493 (i.e., special purposed devices can be optimized so an operating system 493 is merged with applications 494 and/or modules 495), applications 494, and other executable modules 495. The operating system 493 can include mobile device operating systems, desktop operating systems, server operating system, virtual operating systems, and/or distributed operating systems.

Unlike many computing systems, system 400 can be a security sensitive one where data classifications are highly important. That is, information acquired from data sources 150, stored in VOX GIS 440, and used to drive simulation devices 220 can include unclassified, secret, top secret (including compartmentalizations) information. Classification components 404, 414, 424 can exist, which implement comprehensive and conservative rules to automatically classify information into appropriate classifications. Additionally, sanitizers (e.g., sanitizer 426) can be used in system 400 to downgrade semantic content (e.g., from secret to unclassified, for example) of conveyed data elements to ensure that classification based restrictions are not violated. Moreover, different network 460 channels and information handling standards can be imposed based on classification level of the information being conveyed. A further complication is that aggregating and/or analyzing data from different sources 150 can change a classification level of the base data. Automated mechanisms (i.e., classifier 414, aggregator 428, and/or Voxel GIS 440, when aggregating data from multiple sources 150, can reevaluate and appropriately adjust resultant security classification levels) to conservatively handle data classifications are needed in system 400, especially in embodiments where data acquisition to model production (e.g., duration 212 of embodiment 210, for instance) is expedited.

The security sensitivity requirements can result in physically separate channels (e.g., within network 460, for example) for information conveyance. Further, storage regions for the different data classifications (e.g., within Voxel GIS 440, for example) can remain isolated from each other. Known standards for handling classified information exist as do a myriad of automated techniques, which can be utilized for system 400. Various components (classifier 404, 414, 424, security manager 442, sanitizer 426) are shown in system 400 to express that system 400 can implement security classification technologies. Comprehensive coverage of these known technologies is not the focus of this disclosure. For simplicity of expression, classification techniques have not been overly elaborated upon herein. It should be understood that integration of classification specific techniques for information handling are contemplated for the disclosure.

It should also be acknowledged that the specific arrangements of system 400 are expected to vary from implementation-to-implementation. For example, discrete network 460 attached servers are shown for intake (intake server 410) and outtake (outtake server 420) of information to and from the Voxel GIS 440. As shown, intake server 410 can perform intake processing operations (process 310, for example). Outtake server 420 can perform out taking processing operations (process 350 and/or 370, for example). In one embodiment, operations attributed to server 410 or 420 can be integrated into the Voxel GIS 440 or other system 400 components (e.g., one or more intake server 410 operations can be performed by data source 150; one or more outtake server 420 operations can be performed by simulation device 220). For example, in one embodiment, pre-processing unit 402 can optionally perform operations described for normalizer 160 and/or data to volume unit mapping component 162.

Additional components not explicitly expressed in association with system 400, which are consistent with performing operations described in the disclosure, are to be considered present in system 400. Further, logical mappings from system 400 components to operations described herein are assumed to be present. For example, in various contemplated embodiments, compactor 444 can perform operations described in step 340 of FIG. 3A; semantic optimizer 446 can perform operations described in step 338 of FIG. 3A; and, confidence adjustor 416 can perform operations previously described in step 330 and 338. Further, operations of the output generator 172 are to be considered as being performed by components of simulation device 220.

Turning to Voxel GIS 440, a number of characteristics should be noted. First, as new information for Voxel GIS 440 is acquired (from data sources 150); a probability distribution of surface location and surface appearance can be dynamically and programmatically constructed (using Bayesian statistical learning algorithms, for example). In this sense, voxels of the GIS 440 do not store a fixed appearance (of volume units 112 from a real-world volumetric space 110) but instead store a dynamic probability of multiple appearances, which can be learned and/or refined over time.

This characteristic of GIS 440 not only permits efficient handling of uncertainty, but turns traditional data overload challenges into an advantage. That is, over time, information acquisition via satellites, SIGINT, and other automated sources has geometrically increased. Concurrently, a quantity of human analysts responsible for rapidly responding to acquired information has decreased and/or remained constant. In the past, different information channels or products from different sources 150 were handled in a stove-piped manner. Different human analysts would receive and/or analyze satellite data, SIGINT data, HUMINT, PHYOP data, and the like. One result of this situation is that collected data is often not be analyzed in a timely manner. Additionally, collected data is typically analyzed in isolation (e.g., single images from satellites are analyzed by people lacking pertinent geospatial related data from other sources 150). Fusion tools are currently deficient and/or lacking, which is a situation expected to worsen in absence of a paradigm shift in how information is managed and analyzed. The Voxel GIS 440 is a central component for this needed paradigm shift.

To elaborate using diagram 510, Voxel GIS 440 is able to efficiently aggregate information. This aggregation efficiency actually accelerates as information density increases. For example, as a number of images encoded within GIS increases, Voxel GIS 440 storage requirements can actually decrease (or at least become more efficient than the straight line increase experienced using a traditional GIS). Aggregation efficiency results from the “holographic-like” nature of voxel storage space, where an increase in information density increases clarity of the voxel space 120. Uncertainty is reduced, which can reduce storage requirements (e.g., decreasing overhead needed for maintaining “noise” or abnormal data points in voxel space 120).

Aggregation efficiency of the Voxel GIS 440 is represented in diagram 510 by a set of images 520-526 of a stored voxel space. The images 520-526 are static geospatial images of real-world terrain taken from satellite images, yet the demonstrated principle is consistent regardless of the specific input being encoded in voxel space. For example, as more information is captured for individuals in a population, social characteristics of the population become increasingly refined.

Image 520 shows a visual depiction of a voxel space formed from ten images. Image 522 shows the same voxel space after 20 images have been processed. Image 524 shows the voxel space after 30 images. Image 526 shows same voxel space, that has been refined using LIDAR points in conjunction with the thirty images. As shown, it becomes evident that an increase in information density decreases uncertainty of an encoded voxel space and increases “fidelity” of the stored information. That is, as information density increases surface probabilities become better defined. More voxels (and associated data) in “empty space” can be discarded.

It can be mathematically shown that as information density approaches infinity, storage space requirements for the Voxel GIS 440 approaches (effectively equals) a theoretical minimal storage space required by the imagery (and/or data elements being stored). At relatively low information densities (compared to that currently being handled by intelligence agencies) a cross-over point 514 occurs, where it is more efficient to store equivalent data within a Voxel GIS 440 than it is to store equivalent data in a non-voxel GIS (e.g., a conventional GIS). Post cross-over point 514 voxel GIS 440 storage space advantages continue to increase, as shown by chart 512. It should be noted that although many examples presented herein are in context of intelligence activities, Voxel GIS 440 aggregation efficiencies and techniques are domain independent can be used for any geospatial data set.

In voxel database 440 information can be indexed against voxels in different manners. In one embodiment, some records 132 can be directly indexed against uniquely identified voxels (in voxel database 130, for example). Other records 452 can be indexed against features, which are stored in a feature data base 450. Cross indexing between voxel database 130 and feature database 450 can occur.

A feature can be a representation of an object in a physical world (or a simulated object) having its own unique identity and characteristics. Buildings, trees, highways, rivers, lakes, and the like are examples of features. A volume in voxel space 120 occupied by a feature can be defined by a volumetric envelope. The volumetric envelope can be composed of one or more shape primitives. Shape primitives can be a set of basic volumetric shapes that are easily defined by a relatively small number of numeric parameters.

When features and voxel references are both stored in the voxel GIS 440, different consistent semantic mappings can be utilized. In one embodiment, voxel-level semantic content 456 can include spectral signature attributes (e.g., Multispectral Imaging (MSI), Hyperspectral Imaging (HSI), etc.), visual attributes (relating to a human's sense of sight), olfaction attributes (relating to a human's sense of smell), audition attributes (relating to a human's sense of hearing), gustation attributes (relating to a human's sense of taste), somatosensory attributes (relating to a humans sense of touch, temperature, proprioception, and nociception), material composition attributes, and the like.

Diagram 530 provides an illustrated example for describing features. In diagram 530, an envelope 534 of a voxel space 532 can contain features 540 and 542. Feature 540 can be uniquely identified as Feature0001, which is a feature identifier. The feature type of Feature 540 can be a building. Feature 542 can be an air conditioning unit positioned on top of the building. As shown, each feature 540, 542 is formed from single shape primitives 550 and 552, which are both boxes. Features can include any number (from 1 to N) of shape primitives. Each shape can include (be mapped to) a set of voxels. For example, three voxels 560 can form shape 550. In one embodiment, the voxel GIS 340 can include software implemented tools to automatically detect and define shapes, features, and envelopes in a given voxel space.

While any number of shape primitives can be supported by system 400, some common shape primitives include boxes, cylinders, spheres, and cones.

In one embodiment, shape primitives used by system 400 can conform to existing standards for enhanced compatibility. For example, shape primitives can conform to Open Graphics Library (OpenGL) standards for 3D computer graphics. In one embodiment, Coin3D, which is a C++ object oriented retained mode 3D graphics Application Program Interface (API) used to provide a higher layer of programming for OpenGL, objects can be mapped to shape primitives as follows: a box equates to a SoCube; a cylinder equates to a SoCylinder; a sphere equates to a SoSphere; and, a cube equates to a SoCone. In another embodiment, mappings to geospatial scheme of the National Geospatial-Intelligence Agency (NGA) can be as follows: a box equates to a RectangularPrism; a cylinder equates to a Vertical Cylindrical; a sphere equates to a spherical; and, a cube can have no equivalent. In still another embodiment, mappings to a computer aided design (CAD) scheme can be as follows: a box equates to an Axis Aligned Bounding Box (AABB); a cylinder equates to a Cylinder, Flat Ends; a sphere equates to a Cylinder, Round Ends, Zero Length; and, a cube can have no equivalent.

In one embodiment, the voxel query engine 167 of the Voxel GIS 440 can perform seamless and user transparent queries across the different databases 130, 450. It should be noted, that although being referred to as different databases 130, 450 a single unified database (or other indexed repository) can be utilized in the disclosure for both voxel-indexed records 132 and feature indexed records 452.

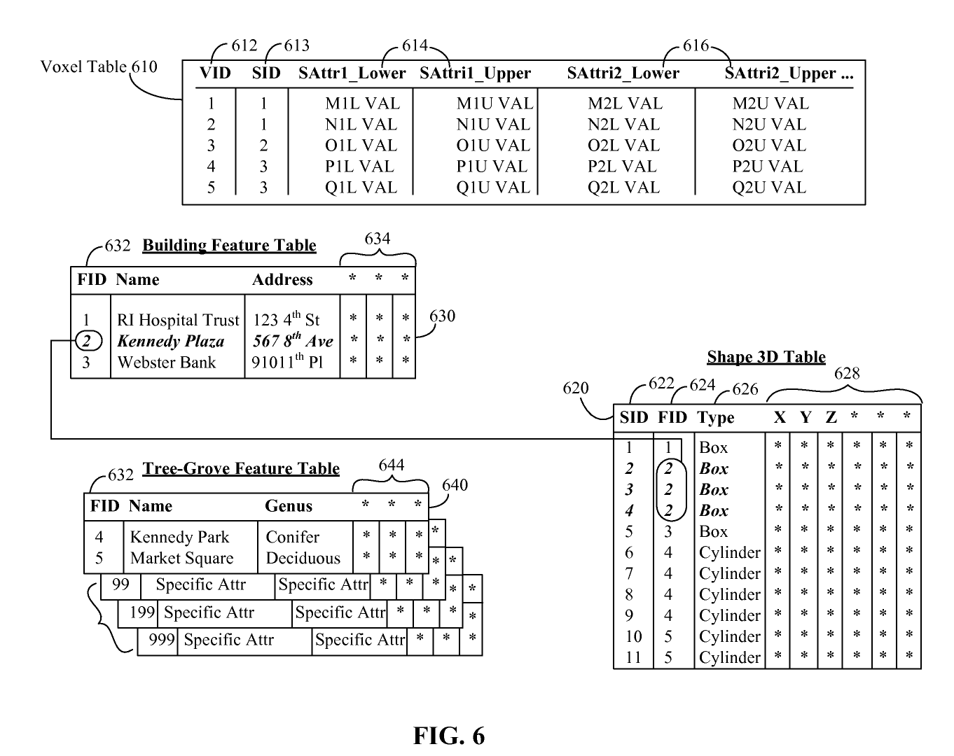

FIG. 6 illustrates a set of tables 610, 620, 630, 640 for a voxel GIS in accordance with an embodiment of the disclosure. In one embodiment, the tables 610, 620, 630, 640 can be RDBMS tables in third normal form. The tables 610, 620, 630, 640 can include a plurality of records (e.g., records 132 and 452).

Voxel table 610 includes a VID 612, which is a unique identifier for each voxel. SID 613 can be a unique identifier for a shape primitive which forms all or part of a shape envelope. Any quantity (1 . . . N) of attributes can be associated with each unique voxel of table 610. For example, each detailed semantic content element 456 can have an associated attribute 614, 616. In one embodiment, each attribute 614, 616 in the voxel table 610 can have at least two values, such as a lower value and an upper value. The multiple values can be used to record different levels of certainty for each attribute 614, 616. For example, one source can report a first value of an attribute 614, 616 with a definable degree of certainty and a different value can be reported for the same attribute 614, 616 with a different degree of certainty. Although two values (lower and upper) are shown for each attribute 614, 616, any number of values (1 . . . N) can be used in table 610.

Each record in shape table 620 can includes a unique shape identifier, SID 622. A secondary key for a feature ID 624 can also be included. Table 620 can also include a type 626 attribute. A set (0 . . . N) of additional shape specific attributes 628 can also exist.

Each unique feature can be associated with a feature identifier, FID 632. In one implementation, different types of tables 630, 640 can exist, one for each unique category or type of object, which corresponds to a feature. For example, one table 630 can exist for buildings and another table 640 can exist for tree groves. Each table 630, 640 can have an associated set of attributes 634, 644, which are unique to a specific type of object. It should be appreciated that arrangements of tables 610, 620, 630, 640 are presented to illustrate a concept expressed herein and are not to be construed as a limitation of the disclosure.

The disclosure may be embodied as a method, system, or computer program product. Accordingly, the disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the disclosure may take the form of a computer program product on a computer-usable storage medium having computer-usable program code embodied in the medium. In a preferred embodiment, the disclosure is implemented in software which includes, but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, or transport the program for use by or in connection with the instruction execution system, apparatus, or device. Any suitable computer-usable or computer-readable medium may be utilized. The computer-usable or computer-readable medium may be, for example but not limited to, an electronic, magnetic, optical, electromagnetic, infrared, or semiconductor system, apparatus, or device. Examples of a computer-readable medium include a semiconductor or solid state memory, magnetic tape, a removable computer diskette, a random access memory (RAM), a read-only memory (ROM), an erasable programmable read-only memory (EPROM) or Flash memory, a rigid magnetic disk and an optical disk. Current examples of optical disks include compact disk-read only memory (CD-ROM), compact disk-read/write (CD-R/W) and DVD.

Computer program code for carrying out operations of the disclosure may be written in an object-oriented programming language such as JAVA, Smalltalk, C++, or the like. However, the computer program code for carrying out operations of the disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN), a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The disclosure is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

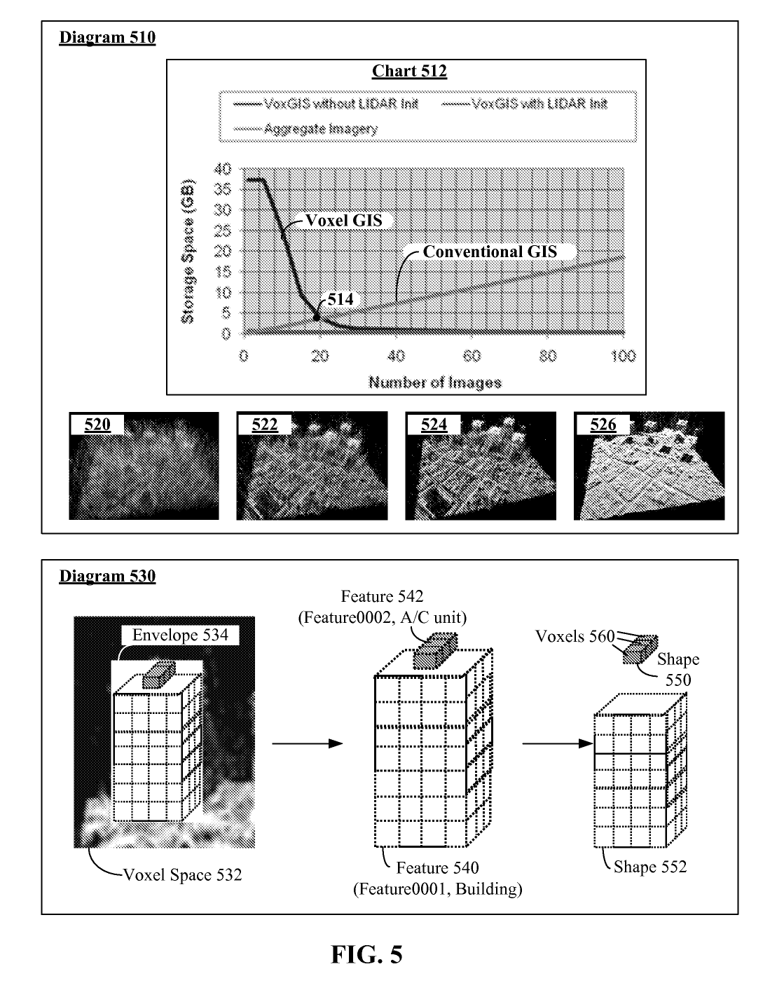

The diagrams in FIGS. 1-6 illustrate the architecture, functionality, and operation of possible implementations of systems, methods, and computer program products according to various embodiments of the disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A voxel database representing a volumetric storage space comprising a set of unique volumetric storage units called voxels, wherein data elements are stored to the voxels, wherein a spatial position of the data elements within the volumetric storage space is defined at least in part by which of the voxels the data elements are stored to, wherein said data elements comprise a plurality of different social characteristics or different cultural conditions, each spatially positioned within a sub-volume of the volumetric storage space defined by the voxels to which the different social characteristics or different cultural conditions are stored.

2. The voxel database of claim 1, wherein the data elements of the volumetric storage space when stored in the voxel database are referenced against voxels and are not directly referenced against other defined objects present in the volumetric storage space.

3. The voxel database of claim 1, wherein said data elements comprise the plurality of different social characteristics, wherein different ones of said different social characteristics apply to an appearance, attire, and behavior of humans present in the corresponding sub-volume of the volumetric storage space.

4. The voxel database of claim 1, wherein the data elements comprise the plurality of different cultural conditions, wherein different ones of said different cultural conditions apply to an architecture of physical structures, political structures, and technology infrastructures in the corresponding sub-volume of the volumetric storage space.

5. A method for modeling population behavior comprising:
receiving spatially referenced information of a sub-volume of real-world volumetric space comprising a population of humans;
analyzing the spatially referenced information to determine a set of social characteristics and cultural conditions for the sub-volume; and
storing the determined social characteristics and cultural conditions in a voxel database, said voxel database representing a volumetric storage space comprising a set of unique volumetric storage units called voxels, wherein data elements are stored against specific ones of the voxels, wherein a spatial position of the data elements within the volumetric storage space is defined at least in part by which of the voxels the data elements are stored against, wherein the social characteristics and cultural conditions are stored as data elements in voxels, where specific ones of the voxels corresponding to volumetric units of the sub-volume.

6. The method of claim 5, further comprising:
determining a sub-volume of simulation space;
extracting data elements from a sub-volume of the volumetric storage space that corresponds to the sub-volume of simulation space;
applying the social characteristics and cultural conditions of the sub-volume of the volumetric storage space to the sub-volume of simulation space; and
permitting a user to interact with a computer controlled population in the sub-volume of the simulation space via an interactive user interface, wherein the interactions are influenced by the social characteristics and cultural conditions.

7. The method of claim 5, further comprising:
generating a computer model for a geospatially bound simulation space using social characteristics and cultural conditions of a sub-volume of the volumetric storage space, where the sub-volume corresponds to the geospatially bound simulation space, wherein the computer model is able used by a simulation device to model social characteristics and cultural conditions of a portion of the real-world volumetric space and the population of humans contained therein, wherein the portion of the real-world volumetric space corresponds to the sub-volume of the volumetric storage space.

8. The method of claim 5, wherein the social characteristics and cultural conditions are further recorded within the voxel database with temporal attributes for a real-world time associated with a time at which the corresponding spatially referenced information was accurate.

9. The method of claim 5, further comprising:
determining from social characteristic data stored in the voxel database and associated with a first time, a volumetric subspace for a population having a values for the social characteristic data falling within a defined range at a defined time, wherein the volumetric subspace is a continuous volume that to volumetric units of the simulation space; and
visually presenting a representation of the volumetric subspace within the simulation space of a simulation user interface along with an indication that the volumetric subspace visually represents a geospatial region comprising a human population predominantly possessing a defined range of social characteristics at the defined time.

10. The method of claim 9, further comprising:
determining boundaries of a different volumetric subspace corresponding to a different time by interpolating boundaries of the different volumetric space from the volumetric subspace associated with the defined time, and another volumetric space derived from data elements of the voxel database; and
visually presenting a representation of the different volumetric subspace within a simulation space of the simulation user interface along with an indication that the different volumetric subspace visually represents a geospatial region comprising a human population predominantly possessing a defined range of social characteristics at the different defined time.

11. The method of claim 5, further comprising:
defining a volumetric simulation space of a simulator comprising a simulated population;
extracting social characteristics and cultural conditions for the simulated population from the voxel database;
presenting within a user interface a defined set of social characteristics, a set of cultural conditions, and region boundary defining options, which are based on the social characteristics and cultural conditions and which are each adjustable based upon user input received via the user interface, wherein at least one value threshold is established for the social characteristics to determine if a given sub-region is affected by the social characteristics;
determining at least one sub-region of the bound geospatial region that satisfies the value threshold of the social characteristic set given the cultural conditions at a defined time; and
presenting a map of a bound region of the volumetric simulation space within the user interface, wherein the bound region is in accordance with the region boundary defining options, visually showing each determined sub-region in a visually distinguishable way to indicate the presence of the social characteristic satisfying the value threshold at the defined time.

12. The method of claim 5, further comprising:
within a feature table, establishing a plurality of feature records in a plurality of feature tables, wherein each of the feature records comprises a unique feature identifier, a feature type, and a plurality of feature attributes, wherein a feature corresponds to a real world object, and wherein the feature attributes of the feature table are specific attributes for the real world objects;
within a shape table, establishing a plurality of shape records, wherein each of the shape records comprises a unique shape identifier, a shape type, a plurality of shape attributes, and a foreign key to a feature identifier, wherein types of shapes are primitive shapes that comprise a box, a cylinder, a sphere, and a cone, wherein a one-to-many relationship exists between features and shapes, wherein each record of the voxel table comprises a foreign key to a shape identifier, wherein a one-to-many relationship exists between voxels and primitive shapes;
querying said voxel database to generate the response set of voxels and feature and shape attribute values corresponding to the set of voxels; and
providing the response set to a simulator having a user interface for a simulated three dimensional volume of space that corresponds to said defined volume of voxel space, wherein the simulator comprises hardware and computer program products stored on a tangible storage medium and executable upon said hardware.

13. A method for simulating population behavior comprising:
defining a volumetric simulation space of a simulator comprising a simulated population;
extracting social characteristics and cultural conditions for the simulated population from a voxel database, said voxel database representing a volumetric storage space comprising a set of unique volumetric storage units called voxels, wherein data elements are stored against specific ones of the voxels, wherein a spatial position of the data elements within the volumetric storage space is defined at least in part by which of the voxels the data elements are stored against, wherein the social characteristics and cultural conditions are stored as data elements in voxels, wherein the volumetric simulation space corresponds to a sub-volume of the volumetric storage space;
presenting within a user interface a defined set of social characteristics, a set of cultural conditions, and region boundary defining options, which are based on the social characteristics and the cultural conditions from the voxel database and which are each adjustable based upon user input received via the user interface, wherein at least one value threshold is established for the social characteristics to determine if a given sub-region is affected by the social characteristics;
determining at least one sub-region of the bound geospatial region that satisfies the value threshold of the social characteristic set given the cultural conditions at a defined time; and
presenting a map of a bound region of the volumetric simulation space within the user interface, wherein the bound region is in accordance with the region boundary defining options, visually showing each determined sub-region in a visually distinguishable way to indicate the presence of the social characteristic satisfying the value threshold at the defined time.

14. The method of claim 13, further comprising:
determining at least one different sub-region of the bound geospatial region that satisfies the value threshold of the social characteristic set given the cultural conditions at a different defined time; and
presenting a map of a bound region of the volumetric simulation space within the user interface, wherein the bound region is in accordance with the region boundary defining options, visually showing each determined different sub-region in a visually distinguishable way to indicate the presence of the social characteristic satisfying the value threshold at the different defined time.

15. The method of claim 14, further comprising:
receiving user input specifying the different defined time via the user interface; and
using the specified defined time as the defined time in the determining step.

16. A method for simulating changes of social characteristics of a geospatially located population comprising:
generating spatially referenced information from a real-world volumetric space using automated sensors, wherein the spatially referenced information comprises information from which social characteristics and cultural conditions for human populations and the real-world volumetric space is able to be automatically determined, wherein the social characteristics and cultural conditions are specific to a specific time at which spatially referenced information was captured from the real-world volumetric space, wherein different portions of the spatially referenced information are acquired at different times, which results in the social characteristics and cultural conditions being captured for the real-world volumetric space at different times;
recording the spatially referenced information in a voxel database, said voxel database representing a volumetric storage space comprising a set of unique volumetric storage units called voxels, wherein data elements are stored against specific ones of the voxels, wherein a spatial position of the data elements within the volumetric storage space is defined at least in part by which of the voxels the data elements are stored against, wherein the social characteristics and cultural conditions are stored as data elements in voxels, wherein different data elements are associated with different times; and
generating a simulated space within a simulation user interface based data elements extracted from the voxel database, wherein visual elements of the simulated space are directly rendered from the visual data stored in raster format by a voxel rendering engine of a simulator that includes the simulation user interface, wherein the simulation space depicts a specific time, wherein a delineated sub-region is visually expressed within the simulated space that denotes a social characteristic of a simulated population present in the sub-region at the specific time, wherein the social characteristics data used to generate the simulation space is extracted from the social characteristics of the voxel database for approximately the specific time, wherein a correspondence exists between volumetric units of the real-world volumetric space and voxels, and wherein a correspondence exits between volumetric units of the simulation space and voxels.

17. The method of claim 16, further comprising:
determining boundaries of a different delineated sub-region corresponding to a different time by interpolating boundaries of the different delineated sub-region from the delineated sub-region associated with the specific time, and another delineated sub-region derived from voxel database data; and
visually presenting a representation of the different delineated sub-region within the simulation space of the simulation user interface along with an indication that the different delineated sub-region visually represents a geospatial region comprising a human population predominantly possessing a defined range of the social characteristics at the different time.

18. A method for determining and presenting social characteristics of a human population in a simulation space of a user interface comprising:
storing a plurality of geospatial records in a voxel database, wherein the records comprise data from a plurality of different sources captured at different times for a real-world volumetric space, wherein the records comprise data for social characteristics of human populations at specific times, wherein each social characteristic is indexed against a set of uniquely defined voxels;
determining from social characteristic data stored in the voxel database and associated with a first time, a first volumetric subspace for a population having a values for the social characteristic data falling within a defined range at the first time, wherein the first volumetric subspace is a continuous volume that directly maps to volumetric units of a simulation subspace, which have a correspondence to voxels of the voxel database;
determining from social characteristic data stored in the voxel database and associated with a second time, a second volumetric subspace for the population having a values for the social characteristic data falling within the defined range at the second time, wherein the second volumetric subspace is a continuous volume that directly maps to regular volumetric units of the simulation subspace, wherein the second volumetric subspace is different from the first volumetric subspace;
receiving a request for presenting a volumetric subspace for the population having values of the social characteristic data within the defined range at a third time;
determining boundaries of a third volumetric subspace by establishing a mathematical relationship between the first, second, and third times and applying the established mathematical relationship to the first, second, and third volumetric space, thereby interpolating boundaries of the third volumetric space from the first volumetric subspace and the second volumetric subspace; and
visually presenting a representation of the third volumetric subspace within a simulation space of a simulation user interface along with an indication that the third volumetric subspace visually represents a geospatial region comprising a human population predominantly possessing the defined range of social characteristics at the third time.

19. The method of claim 18, further comprising:
presenting within the simulation user interface a defined set of social characteristics, a set of cultural conditions, and region boundary defining options, which are based on information of the voxel database and which are each adjustable based upon user input received via the user interface, wherein at least one value threshold is established for the social characteristics to determine if a given sub-region is affected by the social characteristics;
receiving a user input via the simulation user interface;
adjusting the third volumetric subspace in accordance with the user input; and
refreshing the visual presentation of the representation of the third volumetric subspace in accordance with results of the adjusting.

20. The method of claim 18, further comprising:
receiving a plurality of digital products of a real-world volumetric space comprising a population of humans, wherein said different digital products are generated from said plurality of different sources;
analyzing said digital products to determine a set of social characteristics and cultural conditions for the population; and
storing the determined social characteristics and cultural conditions in the voxel database as the geospatial records, wherein the social characteristics and cultural characteristics are recorded with geospatial metrics for the real-world volumetric space in which they occurred, wherein regular volumetric units of the real-world volumetric space correspond to uniquely identified voxels in the voxel database, wherein the storing of the determined social characteristics and cultural conditions comprises indexing values for the determined social characteristics and cultural conditions against a plurality of records, each of which comprises a unique voxel identifier for one of the voxels to which a corresponding regular volumetric unit relates.

21. A computer program product for determining and presenting social characteristics of a human population in a simulation space of a user interface, the computer program product comprising:
a tangible computer readable storage medium having computer usable program code embodied therewith, the computer usable program code comprising:
computer usable program code operable to store a plurality of geospatial records in a voxel database, wherein the records comprise data from a plurality of different sources captured at different times for a real-world volumetric space, wherein the records comprise data for social characteristics of human populations at specific times, wherein each social characteristic is indexed against a set of uniquely defined voxels;
computer usable program code operable to determine from social characteristic data stored in the voxel database and associated with a first time, a first volumetric subspace for a population having a values for the social characteristic data falling within a defined range at the first time, wherein the first volumetric subspace is a continuous volume that directly maps to volumetric units of a simulation subspace, which have a correspondence to voxels of the voxel database;
computer usable program code operable to determine from social characteristic data stored in the voxel database and associated with a second time, a second volumetric subspace for the population having a values for the social characteristic data falling within the defined range at the second time, wherein the second volumetric subspace is a continuous volume that directly maps to regular volumetric units of the simulation subspace, wherein the second volumetric subspace is different from the first volumetric subspace;
computer usable program code operable to receive a request for presenting a volumetric subspace for the population having values of the social characteristic data within the defined range at a third time;
computer usable program code operable to determine boundaries of a third volumetric subspace by establishing a mathematical relationship between the first, second, and third times and applying the established mathematical relationship to the first, second, and third volumetric space, thereby interpolating boundaries of the third volumetric space from the first volumetric subspace and the second volumetric subspace; and
computer usable program code operable to visually present a representation of the third volumetric subspace within a simulation space of a simulation user interface along with an indication that the third volumetric subspace visually represents a geospatial region comprising a human population predominantly possessing the defined range of social characteristics at the third time.

22. A voxel database for storing social characteristics of culturally linked populations within an indexed tangible storage medium, said voxel database comprising:
a plurality of voxel records in a voxel table, where each of the records has a unique voxel identifier, wherein said voxel table is stored in a tangible storage medium;
each voxel record comprising visual attributes of a geometric space, wherein uniquely defined voxels of voxel database is a volume unit of a volumetric storage space, wherein a correspondence exists between voxels and volume units of a real world volumetric space from which geospatial data was directly gathered and encoded within the voxel database;
a plurality of population records, wherein each record has a unique identifier for a set of one or more people, each population record comprises a plurality of different attributes for social characteristics of the corresponding set of people; and
a plurality of time dependent records, each record associating a unique one of the population records to unique set of one or more voxels, at a specific time.
